(19) United States
(12) Patent Application Publication
(10) Pub. No.: US 2006/0244739 A1
(43) Pub. Date: Nov. 2, 2006

(54) Display driver IC and driving method

(75) Inventor: Tsang-Hsiang Tsai, Taichung (TW)

Correspondence Address: BACON & THOMAS, PLLC, 625 SLATERS LANE, FOURTH FLOOR, ALEXANDRIA, VA, 22314, US

(73) Assignee: AU OPTRONICS CORP., Hsin-Chu (TW)

(21) Appl. No.: 11/268,493

(22) Filed: Nov. 8, 2005

(30) Foreign Application Priority Data
Apr. 28, 2005 (TW) 94113753

(51) Int. Cl. G09G 5/00

(52) U.S. Cl. 345/204

(57) ABSTRACT

A display driver IC and a driving method. The display driver IC is for receiving a system signal to drive a display panel or transmit data to a device. The display driver IC includes an input/output interface circuit, an index register, a control register and a device interface circuit. The input/output interface circuit receives the system signal and then outputs a first address signal and a first data signal accordingly. The index register stores and outputs the first address signal. The control register stores the first data signal and outputs the first data signal according to the first address signal output from the index register. The device interface circuit generates a second data signal according to the first data signal and outputs the second data signal to the device.

This application claims the benefit of Taiwan application Serial No. 94113753, filed Apr. 28, 2005, the subject matter of which is incorporated herein by reference.

### BACKGROUND OF THE INVENTION

1. Field of the Invention

The invention relates in general to a display driver IC and a driving method for same, and more particularly to a display driver IC and a method for transmitting data to a device.

2. Description of the Related Art

FIG. 1 shows a conventional display module. Referring to FIG. 1, the display module 100 includes a display panel 130, a display driver IC 110 and a circuit board 120. The display driver IC 110 drives the display panel 130 to display frames. The display driver IC 110 includes an input/output interface circuit 111, an index register 112, a control register 113 and a display driving circuit 114. The display driver IC 110 drives the display panel 130 according to a system signal A0 output from a system 150. The input/output interface circuit 111 receives the system signal A0 output from the system 150 and outputs an address signal A1 and a data signal A2 accordingly. The index register 112 temporarily stores the address signal A1 and outputs the address signal A1 to the control register 113. The control register 113 generates a control signal C4 according to the address signal A1 and the data signal A2. The display driving circuit 114 drives the display panel 130 according to the control signal C4, which is, for example, a command for a power-saving mode or changing the scan frequency.

When additional devices, such as devices 121, 122 and 123, have to be disposed on the circuit board 120 in the display module 100 to meet various requirements in conjunction with various products, the number of pins at the input/output end to be connected to the system 150 has to be increased such that the system 150 can transmit signals C1, C2 and C3 to the devices 121, 122 and 123 through the added pins.

However, increasing the number of pins in the display module when the above-mentioned devices have to be added may have the following drawbacks.

1. The increased number of pins increases the cost.

2. The difficulty of wire bonding to the connection portion of the display module is increased.

3. The difficulty of assembling the display module in the system manufacturer is increased.

4. The areas of the display module and the circuit board of the system are enlarged.

The drawbacks described above greatly decrease the product competition ability.

### SUMMARY OF THE INVENTION

It is therefore an object of the invention to provide a display driver IC and a driving method, in which the number of pins to be connected to a system does not have to be increased when the number of devices in the display module is increased.

The invention achieves the above-identified object by providing a display driver IC for receiving a system signal, which is output from a system, to drive a display panel or transmit data to a device. The display driver IC comprises an input/output interface circuit, an index register, a control register and a device interface circuit. The input/output interface circuit receives a first system signal output from the system and then outputs a first address signal and a first data signal accordingly. The index register temporarily stores and then outputs the first address signal. The control register temporarily stores the first data signal, and outputs the first data signal according to the first address signal output from the index register. The device interface circuit generates a second data signal according to the first data signal and outputs the second data signal to the device.

The invention also achieves the above-identified object by providing a driving method. The driving method comprises the following steps. First, a first system signal is received through an input/output interface circuit to generate a first address signal and a first data signal accordingly. The first address signal is stored temporarily via an index register and the first data signal is stored temporarily via a control register. Next, the first data signal is output through the control register according to the first address signal. Finally, a second data signal, which is generated according to the first data signal, is output to a device through a device interface circuit.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows a conventional display module.

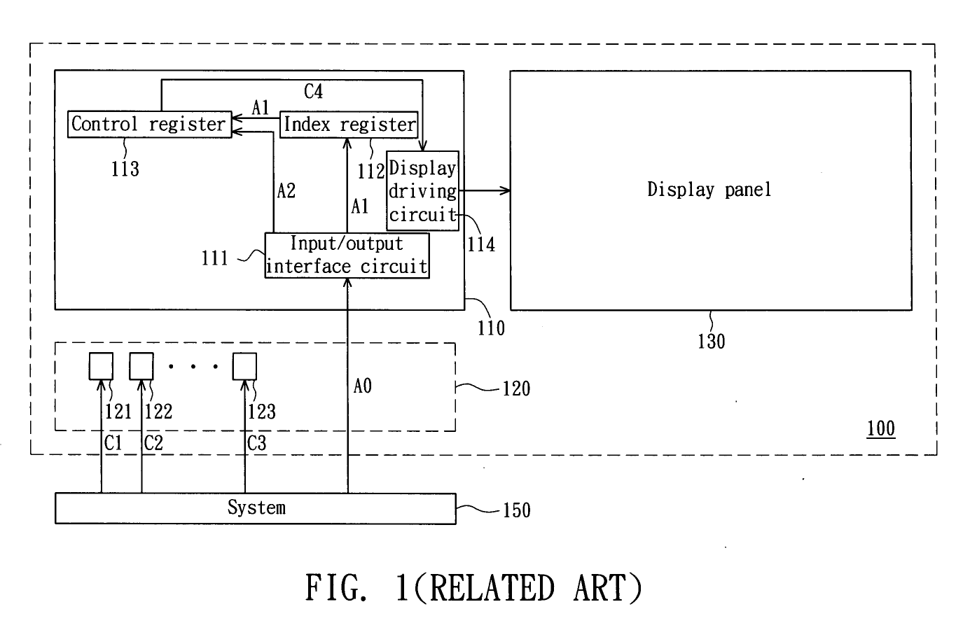

FIG. 2 is a block diagram showing a display module according to a preferred embodiment of the invention.

FIG. 3 is a schematic illustration showing a device communicating in an active manner in a display module according to a preferred embodiment of the invention.

FIG. 4 is a flow chart showing a method of transmitting data between a device and a display driver IC according to a preferred embodiment of the invention.

### DETAILED DESCRIPTION OF THE INVENTION

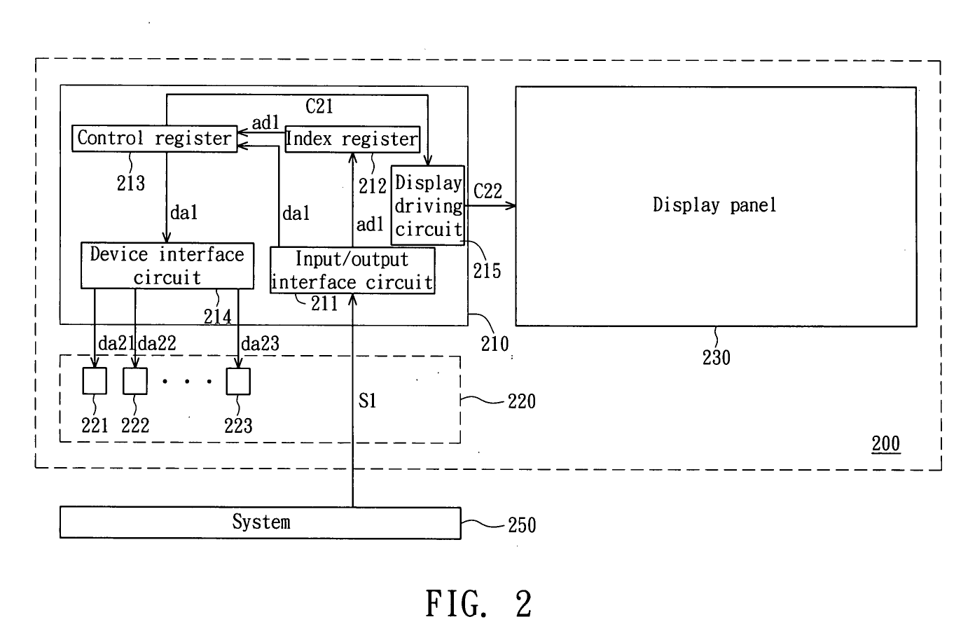

FIG. 2 is a block diagram showing a display module according to a preferred embodiment of the invention. Referring to FIG. 2, a display module 200 comprises a display panel 230, devices 221, 222 and 223 and a display driver IC 210. The display driver IC 210 receives a system signal S1, which is output from a system 250, to drive the display panel 230 and the devices 221 to 223. The display driver IC 210 in this embodiment is electrically connected to a display panel. In practice, however, the display driver IC may also be directly disposed on the display panel, such as a LTPS (Low Temperature Poly-Silicon) display panel.

The display driver IC 210 comprises an input/output interface circuit 211, an index register 212, a control register 213, a device interface circuit 214 and a display driving circuit 215. The input/output interface circuit 211 receives the system signal S1 and then outputs an address signal ad1 and a data signal da1 accordingly. The index register 212 electrically connected to the input/output interface circuit 211 temporarily stores the address signal ad1 and then outputs the address signal ad1. The control register 213 electrically connected to the index register 212 and the input/output interface circuit 211 temporarily stores the data signal da1, and outputs the data signal da1 according to the address signal ad1 output from the index register 212, such that the device interface circuit 214 electrically connected to the control register 213 generates a data signal da21, da22 or da23 according to the data signal da1 and outputs the data signal da21, da22 or da23 to the devices 221 to 223. The device interface circuit 214 includes a General Purpose Input/Output (GPIO) circuit, and the device interface circuit 214 also has the signal-processing function corresponding to the signal required by the device.

The display driving circuit 215 is electrically connected to the control register 213. When the display driver IC 210 drives the display panel 230, the control register 213 outputs a control signal C21 according to the address signal ad1 and the data signal da1. The display driving circuit 215, which is controlled by the control signal C21, transmits a control signal C22 to the display panel 230 to drive the display panel 230. The control signal C21 may be a display command for a power-saving mode, changing the scan frequency, increasing/decreasing the number of displayed colors, or changing the gamma value. The display driving circuit 215 of this embodiment is integrated in the display driver IC 210. In practice, however, the display driving circuit may also be another chip or directly disposed on the display panel, such as a LTPS (Low Temperature Poly-Silicon) display panel.

The control register 213 has a plurality of sub-registers for outputting the data signals da21, da22 and da23 accordingly to the devices 221, 222 and 223, or outputting the control signal C21 to drive the display panel 230. The control register 213 receives the address signal ad1 and the data signal da1, temporarily stores the data signal da1 in its sub-register according to the address signal ad1, and then decides the data signal da1 to drive the display panel 230 or to drive one of the devices according to the address signal ad1. If the data signal da1 is to drive the device, the device interface circuit 214 generates the data signal da21 and outputs the data signal da21 to the device 221, generates the data signal da22 and outputs the data signal da22 to the device 222, or generates the data signal da23 and outputs the data signal da23 to the device 223 according to the data signal da1.

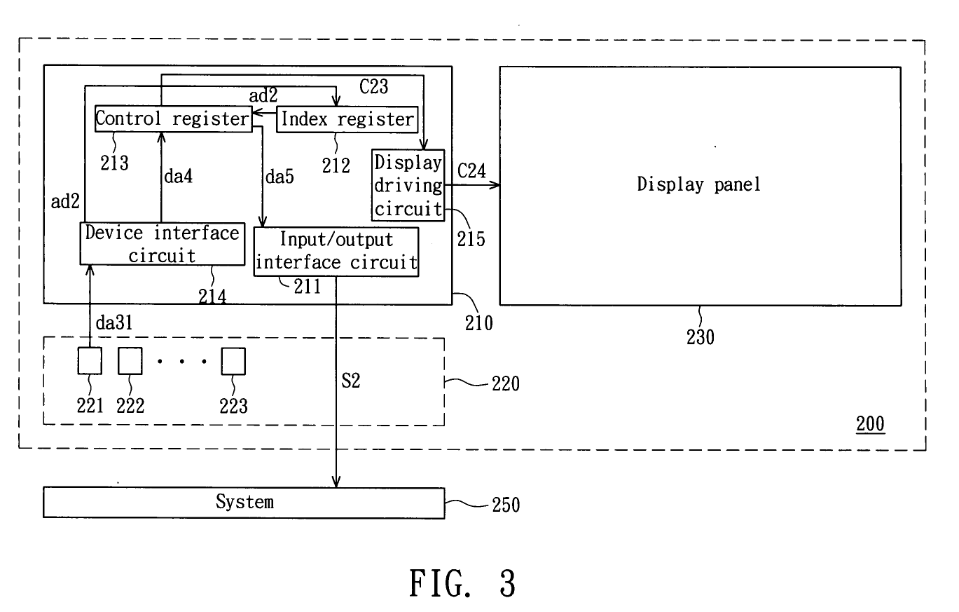

The devices 221 to 223 not only receives the data signal output from the device interface circuit 214, but also communicates with the system 250 in an active manner. FIG. 3 is a schematic illustration showing the device communicating in an active manner in a display module according to a preferred embodiment of the invention. In FIG. 3, the device 221 will be illustrated as an example. When the device 221 wants to communicate with the system 250, the device 221 outputs a data signal da31 to the device interface circuit 214, which generates an address signal ad2 and a data signal da4 in correspondence with the device 221 and the data signal da31. The index register 212 temporarily stores the address signal ad2 and outputs the address signal ad2 to the control register 213. The control register 213 outputs a data signal da5 according to the address signal ad2 and the data signal da4. The input/output interface circuit 211 outputs a system signal S2 to the system 250 according to the data signal da5 so as to communicate the device 221 with the system 250.

Alternatively, the devices 221 to 223 may also drive the display panel 230 in an active manner. As shown in the example of the device 221 of FIG. 3, when the device 221 wants to drive the display panel 230 in an active manner, the device 221 outputs the data signal da31 to the device interface circuit 214, which generates the address signal ad2 and the data signal da4 in correspondence with the device 221 and the data signal da31. The index register 212 temporarily stores the address signal ad2 and outputs the address signal ad2 to the control register 213. The control register 213 outputs a control signal C23 to the display driving circuit 215 according to the address signal ad2 and the data signal da4. The display driving circuit 215 generates a control signal C24 to drive the display panel 230 according to the control signal C23.

The devices 221 to 223 may also communicate with or control one another through the device interface circuit 214. The devices 221 to 223 may be, for example, a LED (Light Emitting Diode) driver, a CCD (Charge Coupled Device) sensor driver, a back light driver, a speaker driver, a voltage regulator driver, a motor driver, a CMOS (Complementary Metal Oxide Semiconductor) sensor driver, or the like.

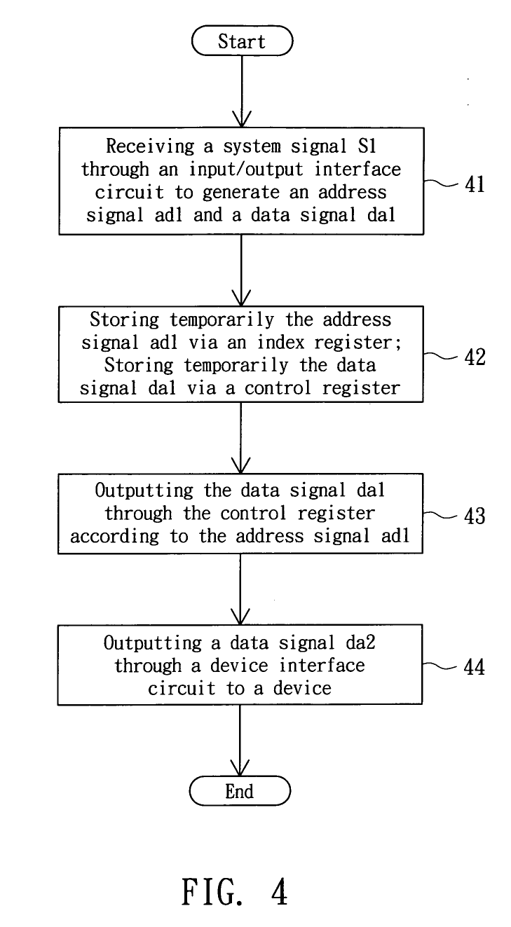

FIG. 4 is a flow chart showing a driving method according to a preferred embodiment of the invention. First, the display driver IC 210 receives a system signal S1 through an input/output interface circuit 211 to generate an address signal ad1 and a data signal da1 accordingly, as shown in step 41. Next, the display driver IC 210 temporarily stores the address signal ad1 via an index register 212, and temporarily stores the data signal da1 via a control register 213, as show in step 42. Outputting the data signal da1 through the control register 213 according to the address signal ad1, as shown in step 43. Thereafter, the display driver IC 210 outputs a data signal da2, generated according to the data signal da1, through a device interface circuit 214 to device 221, 222 or 223, as shown in step 44.

The display driver IC and the method of transmitting data between the display driver IC and the device according to the embodiments of the invention have the following advantages.

1. The number of pins of the circuit board and the system and the cost of the connectors can be decreased.

2. The difficulty of wire bonding to the connection portion of the display module is decreased.

3. The difficulty of assembling the display module in the system manufacturer is decreased.

4. The areas of the display module and the circuit board of the system are reduced.

According to the concept of the invention, the cost loss and other disadvantages will not be caused when the number of devices of the display module is increased.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display driver integrated circuit (IC) electrically connected to a display panel and a device, comprising:
an input/output interface circuit for receiving a first system signal output from a system and for outputting a first address signal and a first data signal;
an index register, electrically connected to the input/output interface circuit, for temporarily storing the first address signal;
a control register, electrically connected to the index register and the input/output interface circuit, for temporarily storing the first data signal and for outputting the first data signal according to the first address signal output from the index register; and
a device interface circuit, electrically connected to the control register, for outputting a second data signal to the device according to the first data signal.

2. The display driver IC according to claim 1, wherein the device interface circuit comprises a General Purpose Input/Output (GPIO) circuit.

3. The display driver IC according to claim 1, further comprising a display driving circuit, electrically connected to the control register, for transmitting a control signal to the display panel.

4. The display driver IC according to claim 1, wherein the device is configured to output a third data signal to the device interface circuit.

5. The display driver IC according to claim 4, wherein the device interface circuit is configured to generate a second address signal and a fourth data signal according to the third data signal.

6. The display driver IC according to claim 5, wherein the index register is configured to temporarily store the second address signal.

7. The display driver IC according to claim 6, wherein the control register is adapted to output a fifth data signal according to the second address signal output from the index register and the fourth data signal.

8. The display driver IC according to claim 7, wherein the input/output interface circuit is configured to output a second system signal to the system according to the fifth data signal.

9. The display driver IC according to claim 1, wherein the control register includes a sub-register for storing the first data signal according to the first address signal.

10. The display driver IC according to claim 1, wherein the device comprises a light emitting diode (LED) driver.

11. The display driver IC according to claim 1, wherein the device comprises a speaker driver.

12. A driving method comprising:
receiving a first system signal through an input/output interface circuit to generate a first address signal and a first data signal;
storing temporarily the first address signal via an index register;
storing temporarily the first data signal via a control register;
outputting the first data signal through the control register according to the first address signal; and
outputting a second data signal, generated according to the first data signal, through a device interface circuit to a device.

13. The method according to claim 12, wherein the second data signal is transmitted through a General Purpose Input/Output (GPIO) circuit.

14. The method according to claim 12, further comprising applying a control signal to a display driving circuit according to the first address signal and the first data signal.

15. The method according to claim 12, further comprising outputting a third data signal from the device.

16. The method according to claim 15, further comprising generating a second address signal and a fourth data signal according to the third data signal through the device interface circuit.

17. The method according to claim 16, further comprising generating a fifth data signal according to the second address signal and the fourth data signal through the control register.

18. The method according to claim 17, further comprising outputting a second system signal to the system according to the fifth data signal through the input/output interface circuit.

19. The method according to claim 16, further comprising applying a control signal to a display driving circuit according to the second address signal and the fourth data signal.

20. The method according to claim 15, wherein the third data signal is transmitted through a General Purpose Input/Output (GPIO) circuit.
